(19) United States
(12) Patent Application Publication
(10) Pub. No.: US 2014/0118549 A1
(43) Pub. Date: May 1, 2014

(54) AUTOMATED VEHICLE PERIPHERY MONITORING APPARATUS AND IMAGE DISPLAYING METHOD

(71) Applicant: NISSAN NORTH AMERICA, INC., Franklin, TN (US)

(72) Inventor: Michael Meldrum, West Bloomfield, MI (US)

(73) Assignee: Nissan North America, Inc., Franklin, TN (US)

(21) Appl. No.: 13/664,999

(22) Filed: Oct. 31, 2012

(51) Int. Cl. H04N 7/18

(52) U.S. Cl. 348/148; 348/E07.085

(57) ABSTRACT

An automated vehicle periphery monitoring apparatus is basically provided with a camera, an image displaying device, a position location device and a controller. The image displaying device is operatively connected to the camera to display an image captured by the camera. The position location device acquires a current location of the automated vehicle periphery monitoring apparatus. The controller is operatively coupled to the image display device and the position location device. The controller is programmed to automatically display the image captured by the camera on the image display device upon determining that the current location of the automated vehicle periphery monitoring apparatus matches a prescribed location.

### BACKGROUND

1. Field of the Invention

The present invention generally relates to a providing an image of a surrounding area of a vehicle to a driver. More specifically, the present invention relates to a vehicle periphery monitoring apparatus and an image displaying method for automatically presenting an image on an image displaying device upon determining that a current location of the automated camera system matches a prescribed location.

2. Background Information

In recent years, many vehicles are provided with a vehicle camera system having an onboard (vehicle-mounted) camera that is used to capture an image of a region adjacent to a vehicle. The image is then displayed on an image displaying device, which is installed inside the vehicle so that a driver can accurately ascertain a situation in the region adjacent to the vehicle. The image displaying device is typically located on the instrument panel, or at any other suitable location within the passenger compartment of the vehicle. One of the most common vehicle camera systems includes a rearview camera that is automatically activated so as to display an image captured by the rearview camera upon determining that the transmission has been shifted into reverse. Sometimes, the driver or a passenger can also manually activate the vehicle camera system by pushing a pressing a designated button.

More advanced vehicle camera systems have been developed for monitoring an entire peripheral area of the vehicle and providing a top plan view image of the vehicle and the surrounding peripheral area of the vehicle. Such a vehicle camera system is sometimes called an around-view monitoring system. With an around-view monitoring system, several cameras are used to capture images of the surrounding peripheral area of the vehicle. The top plan view image of the vehicle and the surrounding peripheral area of the vehicle is sometimes displayed using a split screen image, with a first part of the screen showing one of the images from one of the cameras and a second part of the screen showing a composite image obtained from the images of all of the cameras. An around-view system can be particularly helpful to a driver when the vehicle is entering a garage or other location in which the vehicle typically will have limited maneuverability. Again, these camera images are only displayed to the driver when the transmission has been shifted into reverse, or when the driver or a passenger manually activate the vehicle camera system by pushing a pressing a designated button.

### SUMMARY

In view of the state of the known technology, one aspect presented in the present disclosure is to provide an automated vehicle periphery monitoring apparatus that automatically displays an image captured by the camera upon determining that a current location of the automated camera system matches a prescribed location. This automated vehicle camera system is especially useful in parking situations.

In view of the above, an automated vehicle periphery monitoring apparatus is provided that basically comprises a camera, an image displaying device, a position location device and a controller. The image displaying device is operatively connected to the camera to display an image captured by the camera. The position location device acquires a current location of the automated vehicle periphery monitoring apparatus. The controller is operatively coupled to the image display device and the position location device. The controller is programmed to automatically display the image captured by the camera on the image display device upon determining that the current location of the automated vehicle periphery monitoring apparatus matches a prescribed location.

Other objects, features, aspects and advantages of the disclosed automated vehicle periphery monitoring apparatus will become apparent to those skilled in the art from the following detailed description, which, taken in conjunction with the annexed drawings, discloses preferred embodiments of the automated vehicle periphery monitoring apparatus.

### BRIEF DESCRIPTION OF THE DRAWINGS

Referring now to the attached drawings which form a part of this original disclosure:

FIG. 1 is a schematic diagram of an automated vehicle periphery monitoring apparatus adapted to a host vehicle in accordance with one disclosed embodiment;

FIG. 2 is a schematic diagram of a portion of a passenger compartment including the instrument panel of the vehicle equipped with the automated vehicle periphery monitoring apparatus illustrated in FIG. 1;

FIG. 3 is an elevational view of the image displaying device a first example of an image displayed on an image displaying device of the automated vehicle periphery monitoring apparatus illustrated in FIGS. 1 and 2;

FIG. 4 is an elevational view of the image displaying device a second example of an image displayed on an image displaying device of the automated vehicle periphery monitoring apparatus illustrated in FIGS. 1 and 2; and

FIG. 5 is a flowchart illustrating an example of operations executed by the controller of the vehicle monitoring the automated vehicle periphery monitoring apparatus illustrated in FIG. 1.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

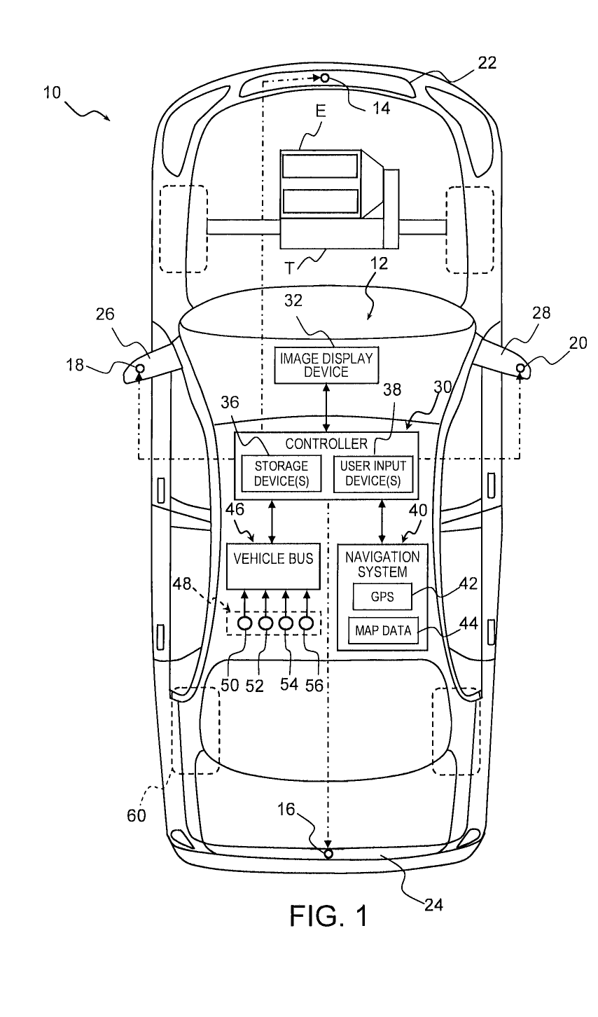

Referring initially to FIG. 1, a host vehicle 10 is illustrated that is equipped with an automated vehicle periphery monitoring apparatus 12 in accordance with a first embodiment. While the vehicle 10 is illustrated having an internal combustion engine E and a transmission T, the automated vehicle periphery monitoring apparatus 12 can be used with other types of vehicles such as hybrid vehicles, electric vehicles and fuel cell vehicles.

As illustrated in FIG. 1, the automated vehicle periphery monitoring apparatus 12 is equipped with a plurality of onboard video cameras that includes a front video camera 14 (i.e., a front camera), a rear video camera 16 (i.e., a rear camera), a first lateral video camera 18 (i.e., a right side camera) and a second lateral video camera 20 (i.e., a left side camera). The front camera 14 is installed on a frontward portion of the vehicle 10, such as at or near the front bumper or grille 22 of the vehicle 10. The rear camera 16 is installed on a rearward portion of the vehicle 10, such as at or near the rear bumper or rear truck lid 24 of the vehicle 10. The right side camera 18 is installed on a right lateral portion of the vehicle 10, such as at or near a right side view mirror 26. The left side camera 20 is installed on a left lateral portion of the vehicle 10, such as at or near the left side view mirror 28. The cameras 14, 16, 18 and 20 constitute an image capturing device of the illustrated embodiment, which is configured and arranged to sequentially capture images (video) of the regions directly forward, rearward and laterally of the vehicle 10. As explained below, the cameras 14, 16, 18 and 20 collectively function as an around-view monitoring system of the vehicle 10.

As illustrated in FIG. 1, the automated vehicle periphery monitoring apparatus 12 also includes a controller 30 (one example of an image processing device) that is configured to generate a display image from the photographed images obtained with the cameras 14, 16, 18 and 20. As explained below, the controller 30 is programmed to automatically operate the display device 32 to display the image captured by the cameras 14, 16, 18 and 20 upon determining that a current location of the automated vehicle periphery monitoring apparatus 12 matches a prescribed location. Thus, the cameras 14, 16, 18 and 20 are operatively connected to the controller 30 in a conventional manner such as using wireless communication or wires such that the controller 30 can control the operations of the cameras 14, 16, 18 and 20.

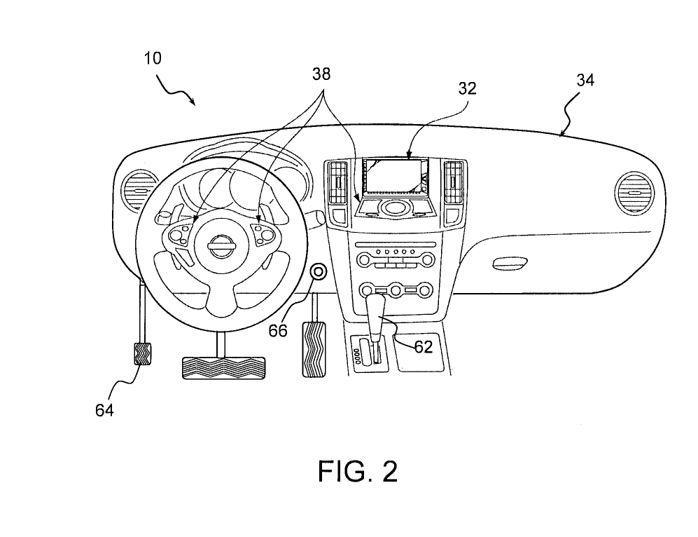

Moreover, the automated vehicle periphery monitoring apparatus 12 further includes a display device 32 (i.e., an image displaying device) that is mounted in an interior of the vehicle 10 such as in an instrument panel 34 of the vehicle 10 as illustrated in FIG. 2. The display device 32 is configured and arranged to display the display image generated by the controller 30 for a driver of the vehicle 10. Thus, the display device 32 is operatively connected to the controller 30 in a conventional manner such as using wireless communication or wires such that the controller 30 can control the operations of the display device 32. More specifically, the controller 30 is configured to generate a video image including the regions directly forward, rearward and laterally of the vehicle 10 based on the images captured by the cameras 14, 16, 18 and 20, and to display the generated image on the display device 32. Thus, the display device 32 is operatively connected to the cameras 14, 16, 18 and 20 via the controller 30 to display images captured by the cameras 14, 16, 18 and 20. In the illustrated embodiment, the controller 30 is programmed to process the images of the cameras 14, 16, 18 and 20 to display a vehicle peripheral view (i.e., a composite 360 degree top view image) around the vehicle 10.

The controller 30 preferably includes a microcomputer with an image processing program that controls the image processing of the images captured by the cameras 14, 16, 18 and 20. The controller 30 can also include other conventional components such as an input interface circuit, an output interface circuit and a various storage devices 36 such as a hard drive, a ROM (Read Only Memory) device and/or a RAM (Random Access Memory) device. The controller 30 also includes various user input devices 38 for inputting data and controlling the operation of the automated vehicle periphery monitoring apparatus 12.

In the illustrated embodiment, the controller 30 is operatively connected to a vehicle navigation system 40 of the vehicle 10. The navigation system 24 is preferably operatively coupled to the display device 32. The navigation system 40 is preferably a conventional navigation system that is configured and arranged to receive global positioning information of the vehicle 10 in a conventional manner. The navigation system 40 basically includes a conventional global positioning system 42 (GPS) and a map data 44. The navigation system 24 can have its own controller with microprocessor and storage, or the processing for the navigation system 24 can be executed by the controller 30 as illustrated herein.

The global positioning system 42 is one example of a position location device that can be used to acquire a current location of the vehicle 10 that is equipped with the automated vehicle periphery monitoring apparatus 12. The global positioning system 42 is configured and arranged to receive global positioning information of the vehicle 10 in a conventional manner. Basically, the global positioning system 42 includes a GPS unit that is a receiver for receiving a signal from a global positioning satellite via a GPS antenna. The signal transmitted from the global positioning satellite is received at regular intervals (e.g. one second) to detect the current position of the vehicle 10. The global positioning system 42 preferably has an accuracy of indicting the actual vehicle position within a few meters or less. This data (current position of the host vehicle) is fed to the controller 30 for processing.

As mentioned above, the controller 30 is operatively coupled to the global positioning system 42 and the map data 44 in a conventional manner. As explained below, the controller 30 receives the current location of the vehicle 10 from the global positioning system 42 and the map data 44 to determine whether a situation exists to automatically display an image captured by one or more of the cameras 14, 16, 18 and 20 on the display device 32 upon determining that the current location matches a prescribed location (e.g., one or more known parking locations, one or more detected parking locations, one or more user selected locations).

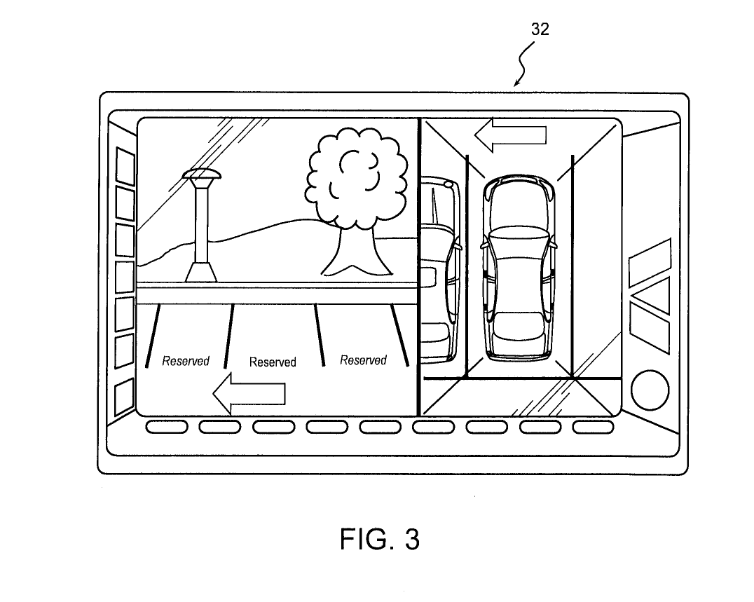

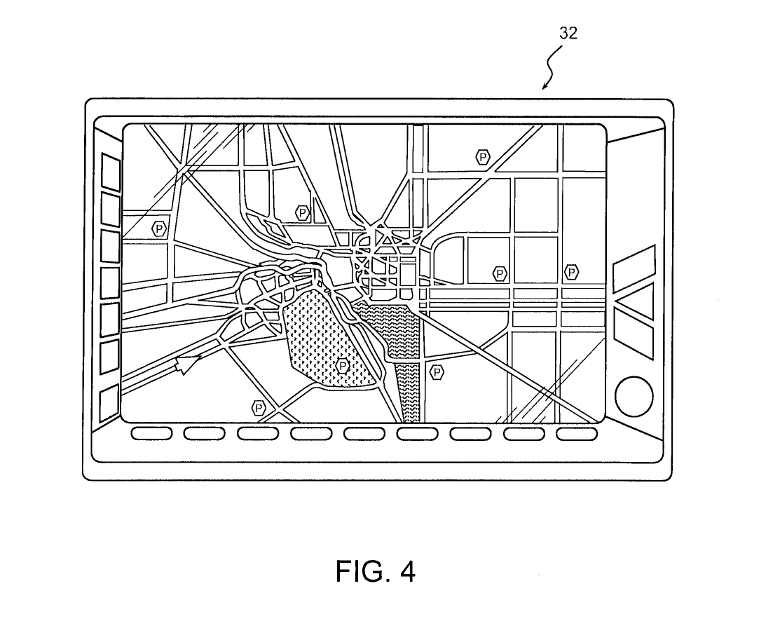

While the automated vehicle periphery monitoring apparatus 12 and the vehicle navigation system 40 are illustrated as separate systems of the vehicle 10, the automated vehicle periphery monitoring apparatus 12 and the vehicle navigation system 40 can be an integrated system with one or more shared components. For example, in the illustrated embodiment, the microcomputer of the controller 30 is programmed to control the operations of the cameras 14, 16, 18 and 20, the display device 32 and the vehicle navigation system 40. Moreover, as seen in FIG. 2, the user input devices 38 are used to operate both the automated vehicle periphery monitoring apparatus 12 and the vehicle navigation system 40. Similarly, the display device 32 displays one or more images generated by the controller 30 from the images captured by the cameras 14, 16, 18 and 20, as seen in FIG. 3, and displays a map of an area surrounding the vehicle 10 as seen in FIG. 4. Thus, the display device 32 displays both images from the cameras 14, 16, 18 and 20 and the map data 44 from the vehicle navigation system 40.

Since periphery monitoring apparatuses and vehicle navigation systems are well known in the automotive field, the precise constructions of the cameras 14, 16, 18 and 20, the display device 32 and the vehicle navigation system 40 will not be discussed and/or illustrated in detail herein. Moreover, while the automated vehicle periphery monitoring apparatus 12 is illustrated with four cameras, the automated vehicle periphery monitoring apparatus 12 can be used with a vehicle that is only equipped with a single camera.

The map data 44 is preferably stored on the vehicle 10 in a map database storage unit that stores road map data as well as other data that can be associated with the road map data such as various landmark data, fueling station locations, restaurants, parking facilities, etc. The map database storage unit for the map data 44 can be in one of the storage devices 36 of the controller 30 or in a separate storage device as needed and/or desired.

In the illustrated embodiment, the vehicle 10 has a vehicle communication bus 46 connected to the controller 30 for connecting a plurality of in-vehicle sensors 48. Here, the vehicle sensors 48 include, but not limited to, a vehicle speed sensor 50, a transmission position sensor 52, a parking brake sensor 54 and an ignition sensor 56. The vehicle speed sensor 50 outputs a vehicle velocity signal, which is indicative of a current vehicle speed, to the controller 30. For example, the vehicle speed sensor 50 can be arranged to detect a rotational speed of at least one vehicle wheel 60. The transmission gear position sensor 52 outputs a transmission gear position, which is indicative of a current gear position of the transmission T, to the controller 30. For example, the transmission gear position sensor 52 can be arranged to detect a position of a gear shift lever 62. The parking brake sensor 54 outputs a parking brake position signal, which is indicative of a current position of a parking brake 64, to the controller 30. The ignition sensor 56 outputs an ignition status signal, which is indicative of a current status of an ignition switch 66, to the controller 30.

As mentioned above, in the illustrated embodiment, the controller 30 is programmed to automatically display an image or images captured by the cameras 14, 16, 18 and 20 on the display device 32 only upon prescribed conditions existing. In the preferred embodiment, the vehicle 10 being located in a prescribed location is the main trigger for automatically displaying an image or images captured by the cameras 14, 16, 18 and 20 on the display device 32. The prescribed location can be set in a variety of ways. Preferably, the prescribed locations are stored in the storage devices 36 of the controller 30. However, with advances in technology, the prescribed locations can be stored at a remote location and communicated to the vehicle 10. As seen in FIG. 4, the map data 44 can include a plurality of known parking locations P as shown on the screen display of the display device 32. Alternatively, the known parking locations P can be stored separately from the map data 44 in the storage devices 36 of the controller 30. In addition to the known parking locations P as prescribed locations, the user can also set user selected locations as prescribed locations. Specifically, the controller 30 is programmed to receive user selected locations via the user input devices 38, and then the controller 30 stores these user selected locations as prescribed locations in the storage devices 36 of the controller 30.

Moreover, the controller 30 is automatically programmed to store at least one parking location as the prescribed location based on historical parking data of the vehicle 10. For example, the controller 30 can track and record the operations of the vehicle 10 such that the controller 30 can determine appropriate situations to automatically display images of the surrounding area of the vehicle. More specifically, the controller 30 can track user end stopping points of the vehicle 10, and then store these user end stopping points as prescribed locations upon determining that the vehicle has stopped at a particular user end stopping point more than a prescribed number of times. Also the controller 30 can track vehicle parking maneuvering operations at a particular location, and then store these locations as prescribed locations upon determining that the vehicle has performed these vehicle parking maneuvering operations at the particular location more than a prescribed number of times.

Alternatively, the controller 30 is automatically programmed to store the current location of the vehicle 10 as a prescribed location upon the controller 30 detecting a predetermined parking operation. For example, the controller 30 is programmed to detect a predetermined parking operation upon detecting placement of a vehicle transmission in a park position, engagement of a parking brake, and/or shutting off the vehicle 10.

Furthermore, the controller 30 is programmed to automatically detect parking location as the prescribed location based on detected operating conditions and/or environmental conditions. For example, using a light sensor, the controller 30 can automatically detect a garage as a parking location by the light sensor detecting a sudden change in vehicle surrounding lighting conditions during daytime hours. Also for example, using the cameras 14, 16, 18 and 20, the controller 30 can automatically detect a parking location by the controller 30 processing the images from the cameras 14, 16, 18 and 20 to detect parking signs, parking space lines, parking meters, and other features indicative of a parking lot and/or a parking space.

Preferably, the controller 30 is programmed to automatically display the image captured by the cameras 14, 16, 18 and 20 on the display device 32 only upon a determination that the vehicle is travelling below a prescribed speed such as 5 mph.

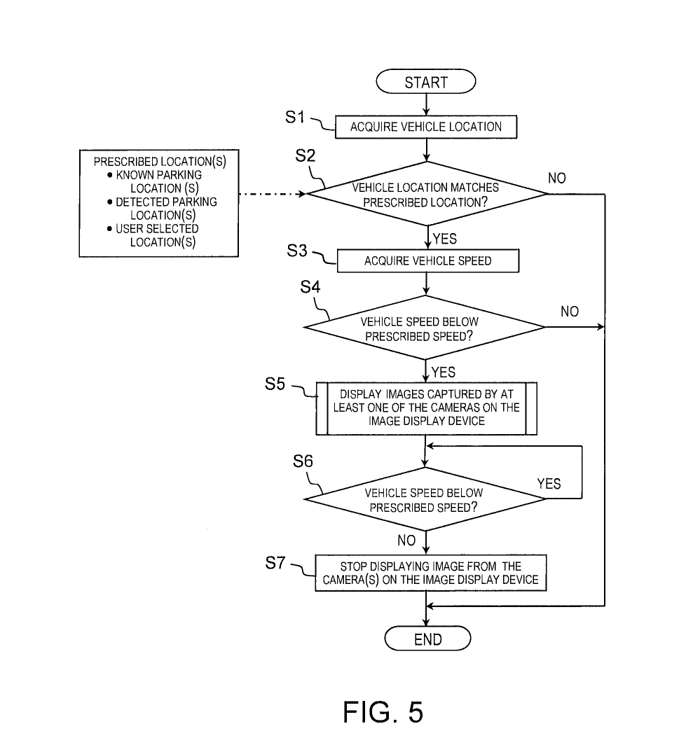

As shown in the flow chart of FIG. 5, the controller 30 executes an automated image displaying method such that an image captured at least one of the cameras 14, 16, 18 and 20 is automatically displayed on the display device 32 without the user performing any action other than driving the vehicle 10 to a prescribed location. Preferably, the automated image displaying method is a vehicle parking assistance method that automatically displays an area around the vehicle 10 on the display device 32 upon the vehicle 10 entering a parking type situation (e.g., a parking lot, a parking garage, a driver's driveway, etc.

Referring to the flow chart of FIG. 5, an example of control operations executed by the controller 30 of the automated vehicle periphery monitoring apparatus 12 will now be explained. Upon starting the vehicle 10, the controller 30 is started. First, the controller 30 reads various sensor data from the storage devices 36 and/or vehicle sensors 48 to initialize the automated vehicle periphery monitoring apparatus 12. Then, the controller 30 begins to execute the control operations of the flow chart of FIG. 5 as well as other control operations as needed and/or desired. The controller 30 executes the control operations of the flow chart of FIG. 5 at a prescribed interval.

In step S1, the controller 30 acquires a current vehicle location from the global positioning system 42 (i.e., the position location device). Then, the controller 30 proceeds to step S1.

In step S2, the controller 30 compares the current vehicle location to all of the prescribed locations that are stored in the storage devices 36 and/or the map data 44. If the current vehicle location matches one of the prescribed locations, then the controller 30 proceeds to step S3.

In step S3, the controller 30 acquires a vehicle speed from the speed sensor 50. Then, the controller 30 proceeds to step S4.

In step S4, the controller 30 compares the current vehicle speed to a prescribed speed that is stored in one of the storage devices 36. If the current vehicle speed is below the prescribed speed, then the controller 30 proceeds to step S5, where the controller 30 displays images captured by at least one of the cameras 14, 16, 18 and 20 on the display device 32 (i.e., the image display device). Thus, the controller 30 activates (i.e., turns on) the display device 32 if the display device 32 is off. If the display device 32 is already on, the controller 30 switches the current image (e.g., a map) with an image generated from one or more of the cameras 14, 16, 18 and 20.

In step S5, the controller 30 executes a subroutine to determine which of the images from the cameras 14, 16, 18 and 20 are to be displayed on the display device 32. If the transmission of the vehicle is in a forward gear, then the controller 30 preferably at least displays the image from the front video camera 14. In FIG. 3, an example of an image displayed on the display device 32 is depicted. Here, in FIG. 3, an image from the front video camera 14 is displayed on the left part of the screen of the display device 32, while a composite image of a top-down view of the vehicle is displayed on the right part of the screen of the display device 32. If the transmission of the vehicle is shifted into reverse, then the controller 30 preferably at least displays the image from the rear video camera 16. More preferably, while the vehicle is in reverse, the controller 30 displays the image from the rear video camera 16 on the left part of the screen of the display device 32, while a composite image of a top-down view of the vehicle is displayed on the right part of the screen of the display device 32.

In step S6, the controller 30 compares the current vehicle speed to a prescribed speed that is stored in one of the storage devices 36. If the current vehicle speed is below the prescribed speed, then the controller 30 continuously monitors the speed of the vehicle 10 with respect to the prescribed speed. Alternatively, another step could be added to determine if the vehicle 10 is no longer in the prescribed location.

If the current vehicle speed is above the prescribed speed, then the controller 30 proceeds to step S7, where the controller 30 turns off the images captured by at least one of the cameras 14, 16, 18 and 20 on the display device 32 (i.e., the image display device) and switches back to the image on the display device 32 that was being displayed prior to the camera image(s) being displayed.

Thus, basically, in the illustrated embodiment, the automated image displaying method includes: detecting a current location of the vehicle 10, which is equipped with the cameras 14, 16, 18 and 20 and the display device 32; automatically determining whether the current location of the vehicle matches a prescribed location that is stored in a storage device; and automatically displaying an image from at least one of the cameras 14, 16, 18 and 20 on the display device 32 of the vehicle 10 upon determining the current location matches the prescribed location. While the automated image displaying method of the illustrated embodiment includes automatically displaying the images from the cameras 14, 16, 18 and 20 on the display device 32, the automated image displaying method can be practiced with a single camera, or any number of cameras.

As mentioned above, in the automated image displaying method, the prescribed location can be a user selected location that is manually inputted and stored as the prescribed location. Also as mentioned above, in the automated image displaying method, the determining of whether the current location of the vehicle matches the prescribed location includes comparing the current location with at least one known parking location, which is stored as the prescribed location, or comparing the current location with at least one parking location, which is stored as the prescribed location, based on historical parking data of the vehicle 10.

As mentioned above, in the automated image displaying method, a current location can be automatically stored as the prescribed location by detecting placement of a vehicle transmission in a park position, engagement of a parking brake, and/or shutdown of the vehicle as the parking operation of the vehicle. Also, in the automated image displaying method, the automatically displaying of the image from the cameras 14, 16, 18 and 20 on the display device 32 can be limited to only when the vehicle 10 is travelling below a prescribed speed.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used ill the singular can have the dual meaning of a single part or a plurality of parts. Also in the above embodiment(s), the term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An automated vehicle periphery monitoring apparatus comprising:
a camera;
an image display device operatively connected to the camera to display an image captured by the camera;
a position location device that acquires a current location of the automated vehicle periphery monitoring apparatus; and
a controller operatively coupled to the image display device and the position location device, the controller being programmed to automatically display the image captured by the camera on the image display device upon determining that the current location of the automated vehicle periphery monitoring apparatus matches a prescribed location.

2. The automated vehicle periphery monitoring apparatus according to claim 1, wherein
the controller includes a storage device and a user input device, the controller being programmed to receive and store as the prescribed location a user selected location.

3. The automated vehicle periphery monitoring apparatus according to claim 1, wherein
the controller includes a storage device with a known parking location stored in the storage device as the prescribed location.

4. The automated vehicle periphery monitoring apparatus according to claim 1, wherein
the controller includes a storage device, the controller being programmed to store at least one parking location as the prescribed location based on historical parking data of the vehicle.

5. The automated vehicle periphery monitoring apparatus according to claim 1, wherein
the controller includes a storage device, the controller being programmed to store the current location as the prescribed location upon the controller detecting a parking operation.

6. The automated vehicle periphery monitoring apparatus according to claim 5, wherein
the controller is programmed to detect the parking operation upon detecting at least one of placement of a vehicle transmission in a park position, engagement of a parking brake, shutdown of the vehicle.

7. The automated vehicle periphery monitoring apparatus according to claim 1, wherein
the controller is programmed to automatically display the image captured by the camera on the image display device only upon a determination that the vehicle is travelling below a prescribed speed.

8. The automated vehicle periphery monitoring apparatus according to claim 1, further comprising
at least one additional camera operatively connected to the image display device to display an image captured by the at least one additional camera.

9. The automated vehicle periphery monitoring apparatus according to claim 8, wherein
the controller is programmed to process the images of the cameras to display a vehicle peripheral view around the vehicle.

10. An automated image displaying method comprising:
detecting a current location of a vehicle equipped with a camera and an image display device;
automatically determining whether the current location of the vehicle matches a prescribed location that is stored in a storage device; and
automatically displaying an image from the camera on the image display device of the vehicle upon determining the current location matches the prescribed location.

11. The automated image displaying method according to claim 10, further comprising
manually inputting and storing as the prescribed location a user selected location.

12. The automated image displaying method according to claim 10, wherein
the determining of whether the current location of the vehicle matches the prescribed location includes comparing the current location with at least one known parking location, which is stored as the prescribed location.

13. The automated image displaying method according to claim 10, further comprising
storing at least one parking location as the prescribed location based on historical parking data of the vehicle.

14. The automated image displaying method according to claim 10, further comprising
storing the current location as the prescribed location upon detecting a parking operation of the vehicle.

15. The automated image displaying method according to claim 14, wherein
the storing of the current location as the prescribed location includes detecting at least one of placement of a vehicle transmission in a park position, engagement of a parking brake, and shutdown of the vehicle as the parking operation of the vehicle.

16. The automated image displaying method according to claim 10, wherein
the automatically displaying of the image from the camera on the image display device only occurs while the vehicle is travelling below a prescribed speed.

17. The automated image displaying method according to claim 10, further comprising
the automatically displaying of the image from the camera on the image display device includes displaying at least another image from at least one additional camera.

18. The automated image displaying method according to claim 17, wherein
the automatically displaying of the images from the cameras on the image display device includes displaying a vehicle peripheral view around the vehicle.
